(19) United States
(12) Patent Application Publication
(10) Pub. No.: US 2025/0255773 A1
(43) Pub. Date: Aug. 14, 2025

(54) SYSTEM, DEVICE AND METHOD FOR PROVIDING DYNAMIC COMPRESSION THERAPY FOR PHYSICAL RECOVERY

(71) Applicant: Mego Afek AC Ltd., Kibbutz Afek (IL)

(72) Inventor: Gilad KENT, Kibbutz Ramat David (IL)

(21) Appl. No.: 19/050,402

(22) Filed: Feb. 11, 2025

Related U.S. Application Data
(60) Provisional application No. 63/552,717, filed on Feb. 13, 2024.

(51) Int. Cl. A61H 9/00

(52) U.S. Cl. CPC A61H 9/0092; A61H 2201/0103; A61H 2201/164; A61H 2201/165; A61H 2230/065

(57) ABSTRACT

Provided herein is a compression system for providing adjusted dynamic compression therapy for recovery from exercise to a subject in need thereof, wherein the operation parameters are adjusted based on health and/or activity data, including, cardiac-related data, derived from signals obtained from a related sensor associated with the subject. Further provided are methods of using the system for determining and/or facilitating recovery from exercise.

### CROSS REFERENCE TO RELATED APPLICATION

This application claims the benefit of priority of U.S. Provisional Patent Application No. 63/552,717, filed Feb. 13, 2024, the contents of which are all incorporated herein by reference in their entirety.

### FIELD OF THE INVENTION

Provided herein are systems, devices and methods for providing dynamic compression therapy for exercise recovery in a subject, utilizing a compression sleeve operative based on health data (such as cardiac-rate related data) and/or exercise data derived from corresponding sensors.

### BACKGROUND

Compression therapy is used to apply controlled pressure to body parts, for example, to improve blood flow, prevent or reduce blood clots formation, and the like. Dynamic compression therapy (DCT), also known as intermittent pneumatic compression (IPC), is a type of compression therapy that uses inflatable garments to apply sequential, pulsating pressure to the limbs. DCT sleeves (garments) are placed on the limbs and then inflated to a given pressure and deflated to a low pressure, repeating this sequence in a cyclic manner increasing blood and lymphatic flow in the compressed limb and in the entire body.

Dynamic compression therapy may be used for different purposes including vascular and cellular functioning recovery for athletes after exercise, to promote recovery.

There is a need in the art for inflatable compression garments capable of providing effective dynamic compression therapy useful to enhance recovery of subjects from physical activity, wherein the therapy is adjusted or customized to the subject, based on the actual recovery levels of the subject.

### SUMMARY

Aspects of the invention, in some embodiments thereof, relate to systems, devices and methods for providing adjusted dynamic compression therapy for recovery from exercise to a subject in need thereof, wherein the operation parameters of the system are adjusted based on health data (for example, cardiac-rate related data) and/or exercise/activity data derived from signals obtained from one or more related sensors associated with the subject. Further provided are methods of using the system for determining and/or facilitating recovery from exercise, based on the health data (such as, cardiac-rate related data) and/or exercise/activity data from a related sensor associated with the subject.

According to some embodiments, the systems and methods disclosed herein are advantageous, as they allow providing a customized and adjusted dynamic compression therapy to a subject recovering from exercise (which can include any type of physical or other activity). The systems and methods disclosed herein advantageously allow determining/identifying/computing the relative recovery level of the subject, by deriving various cardiac (heart) related data from signals obtained from suitable wearable sensors, and based thereon, to determine a suitable/customized dynamic compression therapy to the subject, to enhance exercise recovery.

According to some embodiments, the systems and methods disclosed herein can utilize health and/or exercise/activity data obtained from a wearable device, such as the HealthKit data obtained by an APPLE® watch, to remind a user to use the dynamic compression therapy, and to provide the user with, for example, direction on manually setting timing, duration, program selection, garment selection, and/or other parameters of the dynamic compression therapy, based on that health and/or activity data.

According to some embodiments, the systems and methods disclosed herein can utilize health and/or exercise/activity data obtained from a wearable device, such as the HealthKit data obtained by an APPLE® watch, to remind a user to use the dynamic compression therapy, and to automatically set timing, duration, program selection, garment selection, and/or other parameters of the dynamic compression therapy, based on that health and/or activity data.

According to some embodiments, the systems and methods disclosed herein can utilize continuous input from suitable sensors, such as, heart-related sensors (such as, for example, PPG or ECG sensor), to establish a baseline value for recovery, and based thereon, to optimize recovery routine using dynamic compression therapy after (post) exercise.

Thus, advantageously, using the systems and methods disclosed herein allows achieving a more efficient and better recovery after exercise/activity by applying dynamic compression therapy for recovery after exercise, wherein the therapy can be adjusted based on feedback from related sensors (such as, heart related sensors), which can provide (after processing of the signal) indication of recovery level.

According to some embodiments, there is provided a compression system for providing dynamic compression therapy for recovery from exercise, to a subject in need thereof, the compression system includes:
a wearable compression garment configured to be surroundingly engageable around a limb of the subject, said garment comprising a plurality of inflatable chambers; and
a controller device, configured to control operation parameters of the inflatable chambers, based on health related data and/or activity data, said health related data and/or activity data include cardiac-related data derived from signal(s) obtained from a related sensor associated with the subject; to thereby provide adjusted dynamic compression therapy to the subject to thereby enhance recovery from exercise.

According to some embodiments, the sensor is a wearable sensor. According to some embodiments, the sensor is embedded in the wearable compression garment.

According to some embodiments, sensor is connected to a communication unit of controller device by wired route or wireless route.

According to some embodiments, the sensor may be a photoplethysmogram (PPG) sensor or an electrocardiogram (ECG) sensor.

According to some embodiments, the signal(s) may include electrical activity of the heart or changes in blood volume in peripheral blood vessels.

According to some embodiments, the cardiac related data may be processed by a processing unit of the controller device, or by an external processing unit.

According to some embodiments, the external processing unit is associated with a wearable activity tracking apparatus.

According to some embodiments, the sensor may be housed with the wearable activity tracking apparatus.

According to some embodiments, the wearable activity tracking apparatus may be communicatively associated with the controller device and/or with a mobile computing device.

According to some embodiments, the compression system may be associated with a mobile computing device.

According to some embodiments, the wearable activity tracking apparatus and/or the mobile computing device are configured to execute a method configured to do one or more of:
(i) remind the subject to use the compression system based on the health and/or exercise/activity data;
(ii) provide the subject with instructions for setting operation parameters of the dynamic compression therapy based on the health and/or activity data;
(iii) communicate with the controller device to automatically set the operation parameters of the dynamic compression therapy based on the health and/or activity data.

According to some embodiments, the cardiac related data may be determined continuously, or at discrete time points, over a period of time.

According to some embodiments, the cardiac related data may be determined prior to a compression treatment session, during a compression treatment session and/or after a compression treatment session.

According to some embodiments, a baseline of a cardiac related data may be determined at rest position, prior to or at start of the compression treatment session, to establish a baseline of the cardiac related data.

According to some embodiments, the system may further be configured to compute, by a processor, a trend in the cardiac related data, or parameters related thereof.

According to some embodiments, the cardiac related data may include heart rate, heart rate variability (HRV) and/or parameters related thereto.

According to some embodiments, an increase in the HRV relative to a respective baseline value, and/or a decrease of the heart rate relative to a respective baseline value is indicative of enhanced recovery.

According to some embodiments, a decrease in the HRV relative to a respective baseline value, and/or an increase of the heart rate relative to a respective baseline value is indicative of reduced recovery.

According to some embodiments, the chambers are configured to inflate, deflate or maintain pressure therein, individually, concomitantly and/or sequentially.

According to some embodiments, each of the chambers comprise a ventilation opening configured to allow inflating and/or deflating the bladder.

According to some embodiments, operating parameters comprise one or more of: order of operation of the chambers, length of operation, target pressure in chambers, time to reach or maintain target pressure in chambers, time length to inflate the chamber to a target pressure, time length over which a chamber is inflated (hold time); time length between operation of sequential chambers; frequency of operation; length of compression session.

According to some embodiments, the target pressure within the chambers may be in a range of about 10-150 mmHg.

According to some embodiments, the system further includes a fluid compression unit configured to inflate and/or deflate each of the chambers.

According to some embodiments, the system further includes one or more valves, configured to control pressure the inflatable chambers.

According to some embodiments, the system further includes a user interface.

According to some embodiments, the user interface may include one or more of: keyboard, display, tracking device, touch screen, or any combination thereof.

According to some embodiments, the system may further include a communication unit. In some embodiments, the communication unit includes wired and/or wireless communication modalities. In some embodiments, the communication unit may include Bluetooth communication modality, Wi-Fi communication modality, Near field communication modality (NFC), USB, Ethernet, HDMI, or combinations thereof.

According to some embodiments, the communication unit is configured to enable communication with an external sensor and/or an external processor.

According to some embodiments, the system is configured to adjust the compression treatment in real time, based on continuous determination of the heart-related data.

According to some embodiments, if a value of the cardiac related data is over a respective threshold, indicative of sufficient recovery, the compression therapy is terminated.

According to some embodiments, if a value of the cardiac related data is below a respective threshold, indicative of sufficient recovery, the compression therapy is terminated.

According to some embodiments, if, based on the determined cardiac related data, exercise recovery is determined to be below a threshold value, the compression treatment is continued and/or adjusted.

According to some embodiments, there is provided a method for providing adjusted dynamic compression therapy for recovery from exercise to a subject in need thereof, the method includes:
placing the wearable compression garment as disclosed herein, on a limb of the subject;
determining or receiving cardiac-related data derived from signals obtained from a related sensor associated with the subject; and
controlling the operation of the inflatable chambers, to provide adjusted dynamic compression therapy to the subject, to thereby enhance recovery from exercise.

According to some embodiments, controlling the operation of the inflatable chambers includes reducing, maintaining, or increasing one or more of: pressure in one or more chambers, time to reach pressure, frequency of pressure change(s), order or pressure changes(s), or any combination thereof. Each possibility is a separate embodiment.

According to some embodiments, the method may further include placing one or more sensors on the subject body, prior to treatment session.

According to some embodiments, the method may further include determining a baseline value of the cardiac-related data.

According to some embodiments, the cardiac related data is determined or obtained continuously.

According to some embodiments, the method may further include determining a trend of the cardiac related data over a period of time.

According to some embodiments, the cardiac related data is determined in a processing unit of the controller device, or in an external processing unit.

According to some embodiments, the cardiac related data may include heart rate and/or HRV.

According to some embodiments, the method may further include issuing an alert to the subject regarding the determined status of exercise recovery.

According to some embodiments, the method may further include adjusting one or more treatment parameters, if the obtained cardiac related data or trend thereof, is indicative of exercise recovery below a threshold recovery value.

According to some embodiments, the method may further include providing a compression treatment regime recommendation to the user, based on the obtained cardiac related data or trend thereof.

According to some embodiments, there is provided a method of using a compression system for providing dynamic compression therapy for recovery from exercise, to a subject in need thereof, the method includes:
providing a wearable compression garment configured to be surroundingly engageable around a limb of the subject, said garment comprising a plurality of inflatable chambers; and
providing a controller device, configured to control operation parameters of the inflatable chambers,
providing a wearable sensor worn by a subject user to provide health and/or activity data associated with the subject user;
providing a mobile computing device configured to communicate with the controller device and the wearable sensor, and
providing an application on the mobile computing device wherein the application is configured to do one or more of:
   (i) reminding the subject user to use the compression system based on the health and/or activity data;
   (ii) providing the subject user with instructions for setting the operation parameters of the dynamic compression therapy based on health and/or activity data; or
   (iii) communicating with the controller device to automatically set the operation parameters of the dynamic compression therapy based on the health and/or activity data;
to thereby provide adjusted dynamic compression therapy to the subject to thereby enhance recovery from exercise.

According to some embodiments, the sensor is a wearable sensor. According to some embodiments, the sensor is or is associated with a smart watch. According to some embodiments, the sensor is embedded in the wearable compression garment.

According to some embodiments, the mobile computing device is configured to communicate with the controller device using wireless route comprising Bluetooth, NFC and/or Wi-Fi.

Certain embodiments of the present invention may include some, all, or none of the above advantages. Further advantages may be readily apparent to those skilled in the art from the figures, descriptions, and claims included herein. Aspects and embodiments of the invention are further described in the specification hereinbelow and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1—A perspective front view of a compression system, according to some embodiments;

FIGS. 2A-D—a schematic view of a compression garment, and an exemplary cycle of inflatable chambers operation, according to some embodiments.;

FIG. 3A—a schematic view of a compression system associated with a stand-alone sensor, according to some embodiments;

FIG. 3B—a schematic view of a compression system associated with a sensor included in an activity monitoring apparatus, according to some embodiments;

FIG. 4—block diagram of steps in a method for applying dynamic compression therapy to promote recovery form exercise, according to some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, each of the words “comprise” “include” and “have”, and forms thereof, are not necessarily limited to members in a list with which the words may be associated.

As used herein, “right” and “left” refer to the right and left directions from the center of body of a subject. In some embodiments, left and right are determined by the sagittal plane (longitudinal, anteroposterior), which is parallel to the sagittal suture. In some embodiments, the terms “left” and “left hand side” may interchangeably be used. In some embodiments, the terms “right” and “right hand side” may interchangeably be used.

As used herein, the terms “top” and “bottom” refer to top and bottom directions of a subject body. In some embodiments, “top” is relatively closer to the head region and “lower” is relatively closer to the leg region. In some embodiments, top and bottom are relative to the transverse plane (axial or horizontal plane), which divides the body into cranial and caudal (head and tail) portions.

As used herein, the terms “bladder”, “chamber” and “pocket” may interchangeably be used. The terms relate to a cell capable of being inflated, deflated or maintain fluid therein.

As used herein, the terms “cardiac related data” and “heart related data” may interchangeably be used.

As used herein, the term “health related data” relates to various parameters obtained directly or indirectly from measurements of a sensor associated with the subject. In some embodiments, the health related data includes heart related data (or parameters related thereto). In some embodiments, health related data may be measured and/or computed by the processor of the compression system and/or by an external processor (such as a processor of a mobile computing device (such as a smart phone), a processor of a wearable activity tracking apparatus (such as, a smart watch), etc.).

As used herein, the terms “activity” and “exercise” may be used interchangeably. In some embodiments, the terms relates to various parameters obtained directly or indirectly from measurements of a sensor associated with the subject, related to physical activity of the subject. In some embodiments, the activity/exercise related data may include heart related data (or parameters related thereto). In some embodiments, activity/exercise related data may be measured/computed/determined by the processor of the compression system and/or by an external processor (such as a processor of a mobile computing device (such as a smart phone), a processor of a wearable activity tracking apparatus (such as, a smart watch), etc.).

As used herein, the term “subject” relates to a person/user subjected to compression therapy, in particular, dynamic compression therapy for recovery from exercise. In some embodiments, the subject is an athlete. In some embodiments, the exercise may include any type of physical activity, at any intensity, including, for example, aerobic activity (such as, walking, running, for short or long distances, boxing, jumping, playing ball games, skiing, and the like), anaerobic activity (such as, weight lifting, stretching, yoga, Pilates, and the like), or a combination of aerobic and anaerobic activity (such as, for example, diving, climbing, etc.). In some embodiments, the subject being treated with the compression therapy is laying down during at least a portion of the treatment session. In some embodiments, a subject being treated with the compression therapy is sitting or standing during at least a portion of the treatment session. In some embodiments, a compression therapy session may be applied at any time interval after the exercise (or a plurality of exercises), such as, for example, in the range of minutes (for example, in the range of about 1-60 minutes after the exercise), hours (for example, in the range of 1-24 hours after the exercise), days (for example, 1-14 days after the exercise).

In some embodiments, the compression provided is a pneumatic compression therapy. In some embodiments, the compression therapy includes a session of therapy, in the length of about 1-120 minutes, whereby continuous or intermittent pressure may be applied to the to the subject's body, for example a limb the subject. In some embodiments, the therapy can at least partially enhance, advance, aid and/or support recovery of a subject from exercise. The recovery may result, for example, but not limited to in one or more of: reduced muscle soreness, increased/improved systemic or localized blood circulation, increased/improved blood flow (systemically or localized (e.g., in a treated limb)), increased/improved lymphatic flow (systemic or localized), increased/improved lymphatic drainage, reduced pain, reduced heart rate (during activity or at rest), increased heart rate variability (during activity or at rest), enhanced stability/balance, and the like. In some embodiments, the recovery level, (also referred to herein as recovery degree or recovery status) and/or changes or trends thereof (relative to a previous time point or at rest), may be determined based on heart related data that obtained or derived directly or indirectly based on information from one or more heart related sensors.

As used herein, the term “about” is used to specify a value of a quantity or parameter (e.g. the length of an element) to within a continuous range of values in the neighborhood of (and including) a given (stated) value. According to some embodiments, “about” specifies the value of a parameter to be between 80% and 120% of the given value. According to some embodiments, “about” specifies the value of a parameter to be between 90% and 110% of the given value. According to some embodiments, “about” specifies the value of a parameter to be between 95% and 105% of the given value.

According to some embodiments, there is provided a compression system that includes a wearable compression garment which is configured to be placed on or around a selected body region of the subject (for example, be surroundingly engageable around a limb of the subject), wherein the compression garment includes a plurality of inflatable chambers; and a controller device which is configured to control operation of the inflatable chambers according to a determined recovery level (status) of the subject, wherein the recovery level is determined based on health related data (such as a cardiac (heart) related data) and/or activity related data obtained from one or more suitable sensors. Such advantageous compression system can thus provide adjustable and customized dynamic compression therapy, post exercise, based on the recovery status, to thereby promote or enhance recovery of the subject.

In some embodiments, the provided adjusted dynamic compression therapy (DCT) can improve or enhance recovery by, for example, improving blood flow and lymphatic drainage. Such increased circulation can aid in the removal of metabolic waste products such as lactic acid, which may accumulate during exercise, and/or reduce inflammation in the active muscles, thereby also reducing muscle soreness, muscle tightness or swelling and promoting overall faster and more complete recovery. Thus, by enhancing circulation and reducing muscle soreness, tightness and/or swelling, the provide dynamic compression therapy can expedite and promote a robust recovery process to the subject, allowing returning to training quickly and effectively.

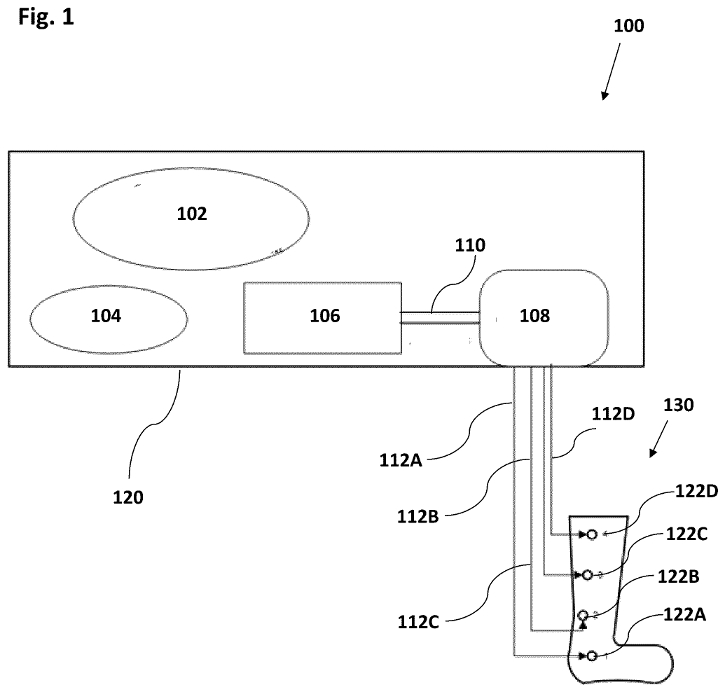

Reference is now made to FIG. 1, which schematically shows a diagram of a system for dynamic compression therapy for exercise recovery, according to some embodiments. As shown in FIG. 1, system 100 includes a controller device 120, which is configured to control operation of inflatable chambers of garment 130, by, for example, controlling the operation of one or more fluid compressors (shown as compressor 106), configured to provide fluid, such as, air, to the inflatable chambers of garment 130. The compressor may be of any suitable type and is configured to provide any suitable amount/pressure of fluids to the inflatable chambers. The passage of fluid to/from the chambers, is facilitated via fluid tubes (collectively numbers as 112), which are configured to connect fluid distribution system 108 (connected to compressor 106 via fluid tubes 110) and the chambers of garment 130. As shown for example, in FIG. 1, compression garment 130 includes four chambers, but can include any number of chambers, at any desired spatial distribution. The chambers may be connected collectively to fluid distribution system 108, via a single fluid tube, or may each be connected by a corresponding tube, as shown for example, in FIG. 1, where fluid tubes 112A-D, are connected to respective chambers 122A-D. Fluid distribution system 108 includes one or more pressure sensors and one or more valves. The valves may be of any type, and in some exemplary embodiments, the valves may be electrical solenoid valves. In some embodiments, each chamber may be associated with or connected to a sperate valve/fluid tube. In some embodiments, one or more chambers may be associated with or connected to a common valve/fluid tube. As further detailed below, each of the inflatable chambers may include a ventilation opening configured to allow the insertion, removal or maintenance of fluid (such as, gas in the form of air) in the bladders, via the fluid tubes. As further detailed herein, the operation of the units of the controller device are controlled by controller unit 102 of the device. Controller unit 102 includes one or more processors, control boards, memory modules, and the like, or combinations thereof. In some embodiments, the processing module may compute, derive or obtain heart related data (directly or indirectly from an associated sensor), and may determine recovery status, or related parameters (such as, change or trend thereof), to recommend or adjust parameters of the compression therapy, as detailed below. In some embodiments, the controller is configured to, inter alia, determine a suitable compression therapy (using, for example a processing unit), based on heart related data directly or indirectly obtained from one or more respective sensors, and based thereon, control operation of inflatable chambers of wearable garment 130, to provide an adjustable or customized dynamic compression therapy, based on recovery status of the subject. In addition, control device 120 may further include a user interface unit (UI). The User interface unit may include one or more of: keyboard, display, tracking device, touch screen, or any combination thereof, allowing a user (such as an athlete or fitness trainer) to interact with the controller device. The interacting with the controller device may include, for example, determining operating parameters, reviewing operating parameters, monitoring operation, and the like. Controller device 120 may further optionally include a communication unit. In some embodiments, the communication unit may include wired and/or wireless communication modalities. In some embodiments, the communication unit may include Bluetooth communication modality, Wi-Fi communication modality, Near field communication modality (NFC), USB, HDMI, ethernet, or combinations thereof. The communication unit may be used to convey information to and from the controller device. In some embodiments, the communication unit is configured to receive input signals from an associated sensor, which may be a stand-alone sensor, sensor embedded in the compression garment 130, or a sensor comprised in another apparatus (e.g., a wearable tracking apparatus). In some embodiments, the communication unit is configured to convey information (receive/output) to a mobile computing device (such as, a smartphone). Controller device 120 further includes a power supply 104 configured to provide electrical power to components of the compression system. Compression garment 130 is configured to be placed on a subject body, at or around a body region (for example, a limb, such as, leg, arm). In some embodiments, as shown in FIG. 1, the compression garment may be in the form of a sleeve, configured to soundingly engage the body region.

According to some embodiments, the controller device may be comprised in a suitable housing. In some embodiments, the controller device may be in the form of a console, which may be stationary or portable.

According to some embodiments, the pressure in each of the chambers (as determined by the amount or pressure of fluid inserted, removed, or maintained in the chamber) may be separately controlled/determined. The chambers may be similar, identical or different therebetween with respect to one or more properties thereof, including, for example, shape, size, form, composition (i.e., material they are made of), physical properties (such as, elasticity), chemical properties, or any combination thereof. Each possibility is a separate embodiment.

According to some embodiments, the chambers may be constructed of any suitable material. For example, walls of the chambers may be made of such materials as, but not limited to: polyethylene (PE), ethylene-vinyl acetate (EVA), or polyvinyl chloride (PVC), thermoplastic polyurethane (TPU), and the like or combinations thereof.

According to some embodiments, the ventilation openings of the chambers are configured to allow for the pumping/insertion of fluid (such as, air) into the chambers, and the outflow of fluid (for example by passive or active deflation) from the chambers, thereby inflating and deflating the chambers. According to some embodiments, the ventilation openings may be in the form of a female connector (for example, in the form of a socketed member), or in the form of a male connector (for example, in the form of tubular spouts). Apart from the fluid connectivity provided by the ventilation openings (fluidly connecting the inside of each of the bladders to the outside), the chambers are essentially fluidly sealed (i.e., airtight). In some embodiments, the ventilation openings are aligned thereto. In some embodiments, the ventilation openings may each be connected to a separate fluid tube/hose. In some embodiments, at least some of the ventilation openings may be connected to a common fluid tube/hose.

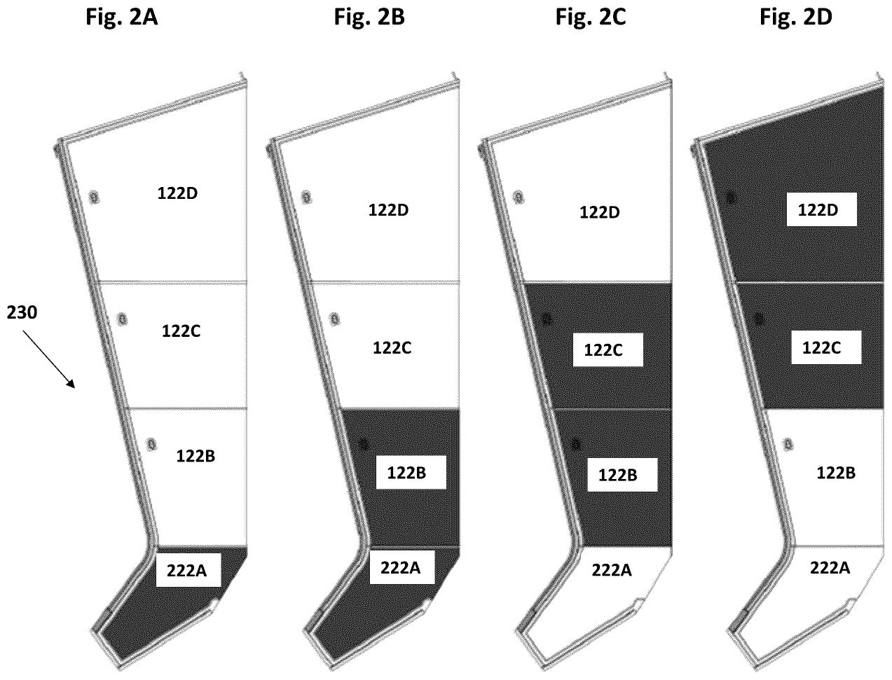

Reference is now made to FIGS. 2A-D, which show a schematic view of a compression garment, and an exemplary cycle of chambers operation, according to some embodiments. As shown in FIGS. 2A-D, compression garment 230 may be in the form of sleeve, including a plurality of chambers, shown as four independent chambers 222A-D. Each chamber may be connected by a corresponding fluid conduit/tube/hose (not shown) to the controller device. The controller is configured to distribute fluid (such as, air), to each chamber according to a given (predetermined) or adjusted, controlled sequence, in order to achieve an efficient clinical effect, by, for example, facilitating larger volumes of blood and lymphatic fluids within the limb, to thereby promote or enhance recovery from exercise. In some embodiments, the chambers may be activated sequentially. For example, the sequential activation may start distally (with the chamber farthest from the body) and sequentially advance proximally (towards the body). Such sequential compression can aid in mobilizing fluid and enhancing circulation. In the Example shown in FIGS. 2A-D, the chambers are activated sequentially (from bottom to top direction (or in other words, in a distal to proximal direction). In FIG. 2A, a first chamber (222A) is inflated (marked as black) to a designated target pressure level, while the other chambers are inflated. Next, as shown in FIG. 2B, once the pressure level is reached in chamber 222A, immediately, or after a time interval, chamber 222B is inflated (marked as black) to a target pressure level. Next, as shown in FIG. 2C, immediately, or after a time period, chamber 222A is deflated (marked as white) and concomitantly with, or sequentially to, chamber 222C is inflated (marked as black) to a target pressure level. Next, shown in FIG. 2D immediately, or after a time period, chamber 222B is deflated (marked as white) and concomitantly with, or sequentially to, chamber 222D is inflated (marked as black) to a target pressure level. The operation cycle may be repeated for any number of times, at any frequency, at any duration, at any desired sequence, at any pressure level, and the like. By controlling/adjusting such operation parameters, the compression therapy may be customized and adjusted, so as to obtain a desired effect.

According to some embodiments, the pressure in each of the chambers (target pressure) may independently be in the range of about 1-150 mmHg. According to some embodiments, the pressure in each of the chambers may independently be in the range of about 10-150 mmHg. According to some embodiments, the pressure in each of the chambers may independently be in the range of about 10-150 mmHg. In some embodiments, each of the chambers may be configured to inflate, deflate or maintain similar or different pressures. In some embodiments, the pressure applied by the garment may be in the range of about 1-150 mmHg, 10-130 mmHg, 15-120 mmHg, or any subranges thereof.

According to some embodiments, the compression garment, or portions thereof may be disposable. According to some embodiments, the compression garment may washable and reusable.

According to some embodiments, in order to determine recovery level of a subject, various heart related parameters or data may be used. For example, such parameters may include for example, but not limited to: heart rate (HR), and values related thereto, including, for example, heart rate variability (HRV), blood oxygen saturation (SpO2), respiratory rate, pulse waveform, parameters derived therefrom, changes in such parameters, trends of such parameters, and the like, or any combinations thereof. Each possibility is a separate embodiment.

According to some embodiments, heart rate variability is a parameter measuring variability of time intervals between adjacent heartbeats. High variability (high HRV value) may be indicative of a more complete physical recovery after exercise, while low variability may indicate lower level of recuperation after exercise. HRV reflects the balance between the sympathetic and parasympathetic branches of the autonomic nervous system. Higher HRV is associated with greater parasympathetic activity and better adaptability to stress, while reduced HRV may indicate autonomic imbalance and increased cardiovascular risk. Thus, HRV measurement may be used for assessing cardiovascular health, monitoring training adaptation in athletes, optimizing recovery, and predicting performance outcomes. In athletes, fluctuations in HRV may indicate fatigue, overtraining, or readiness for high-intensity training. HRV may be computed using various methods (such as, for example, time domain analysis, frequency domain analysis, nonlinear analysis), based on information from various types of sensors, including, for example, photoplethysmogram (PPG), electrocardiogram (ECG), single lead ECG, and the like.

According to some embodiments, the compression system disclosed herein includes or is associated with a heart-related sensor. The heart related sensor may be selected from, but not limited to: a photoplethysmogram or an ECG sensor. The heart related sensor may be a stand-alone sensor, sensor physically associated with or embedded within the compression garment (sleeve), or a sensor harbored or included with an apparatus, such as, an activity tracking apparatus (for example, a wearable tracking smart watch). In some embodiments, the sensor may be placed on any desired body location, such as, for example, wrist, thigh, arm, and the like.

A Photoplethysmography (PPG) sensor may include a non-invasive sensor that utilizes light to measure changes in blood volume in the microvascular bed of tissue. Generally, PPG sensor emits light, typically green or red, into the skin and uses photodetector in the sensor measures the amount of reflected light. As the blood volume in the tissue changes, the amount of reflected light also changes and by computation, those changes can be used for detecting various physiological parameters, such as heart rate, heart rate variability (HRV), blood oxygen saturation (SpO2) and respiratory rate.

A single-lead ECG (also referred to as a rhythm strip), is a simplified type of electrocardiogram (ECG), that uses only one electrode to record the electrical activity of the heart. Single-lead ECG can be measured on almost any region of the body and can be used to detect and monitor heart rate and heart rate variability (HRV).

According to some embodiments, the compression system disclosed herein may be physically and/or functionally associated with an activity tracking device (such as, a smart watch, a sports watch, etc.). In some embodiments, the compression system disclosed herein may be physically and/or functionally associated with a mobile computing device (such as, a smart phone, a tablet, a PC, etc.).

In some embodiments, the computation of the HRV may be facilitated using any methods known in the art, such as, for example, Time Domain Analysis, Frequency Domain Analysis or Nonlinear Analysis. In time domain analysis, HRV is quantified by analyzing the variability in the time intervals between successive heartbeats. Useful Metrics may include, for example, the standard deviation of NN intervals (SDNN) and the root mean square of successive differences (RMSSD). Frequency domain analysis involves decomposing HRV signals into different frequency components using, for example, Fourier transform. Key frequency bands include very low frequency (VLF), low frequency (LF), and high frequency (HF), each reflecting different physiological mechanisms influenced by the autonomic nervous system. Nonlinear analysis is used to determine the complex dynamics of HRV signals, such as entropy and fractal dimension.

According to some embodiments, the sensor may be a stand-alone sensor, that may be embedded with or associated with the system. The sensor may be placed on any region of the body (such as, wrist, arm, hand, thigh), to facilitate obtaining heart related information. The sensor may be in wired or wireless communication with the controller device of the compression system. In some embodiments, information/data/signal obtained from the sensor are conveyed to the processing unit of the controller device, for further processing/computing, to obtain heart related data, such as, HRV and heart rate.

The computation may include any methods for determining HRV, as well as one or more related parameters, such as, trend of the HRV, changes in the HRV between measurements, comparison of HRV to baseline values (such as those obtained at rest), and the like. In some embodiments, based on the determined values, the recovery level, and/or changes in the recovery level may be determined and the compression therapy may be adjusted accordingly, as detailed herein below.

According to some exemplary embodiments, signals received from the stand-alone sensor may be received and computed by the controller device as follows: Initially, measurements are taken in rest position, sensor readings are collected and computed to establish baseline heart rate and/or HRV, which may be stored in the controller device memory. The baseline may be heart rate and/or HRV in state of body rest and may be established after first measurement at rest position. In subsequent uses, the heart rate and/or HRV are computed and compared to the established baseline, evaluating recovery status. As long as computed HRV is lower than baseline and/or heart rate is higher than baseline, it is concluded that further recovery using dynamic compression is needed, and the operating parameters of the dynamic compression may be adjusted accordingly. Thus, if HRV level is below the given threshold and/or heart rate is above a given threshold, the device controller may change/adjust treatment attributes, including, for example, increase compression treatment frequency, increase treatment pressure, treatment duration, treatment order (i.e., order of individual chambers inflation/deflation), and the like. When HRV value is above the given threshold and/or heart rate is below the given threshold the device control unit may further adjust the treatment (including, for example, reduce compression treatment frequency, reduce treatment pressure, treatment duration, treatment order, etc.), or in some cases stop the treatment, while providing an alert (audible, tactile and/or visual), such as in the form of a message to the subject, that recovery status is adequate.

According to some embodiments, obtaining/receiving the signals from the sensor, and adjusting the treatment parameters by the controller device may be performed continuously, throughout the duration of the compression treatment.

According to some embodiments, the controller device may further monitor pattern changes or trends in the values of the cardiac related parameters (such as, HRV and/or heart rate) during treatment and may compare such patterns to known patterns (for example, obtained from a reference database), for evaluating recovery efficiency. The controller device may thus determine that changing/adjusting one or more compression treatment parameters (such as, pressure, frequency. etc.), can result in a treatment being more efficient for recovery of the subject.

According to some embodiments, the controller device can adjust treatment parameters for improving efficiency of recovery session. The adjustment may be performed for example, on duration of treatment, amount of pressure, frequency, order of activated chambers, and the like. For example, at the beginning of (repeated) compression therapy recovery sessions (T₀), HRV and/or heart rate are determined (based on sensor data received by the controller device from a stand-alone sensor). Next, HRV and/or heart rate are measured and computed continuously during recovery session. After T1 period of time, according to previous data patterns (for example, of the subject, or based on respective databases, as detailed above), expected HRV and/or heart values are estimated. An Error coefficient value for HRV and/or heart rate is calculated (for example, based on the difference between the value of the parameters at To and at consecutive time points), and treatment parameters may be based in accordance with the determined Error coefficient. For example, duration of treatment time may be updated, such that the treatment is prolonged for X minutes. For example, pressure values in one or more chambers may be updated, such that the pressure is increased to X mmHg.

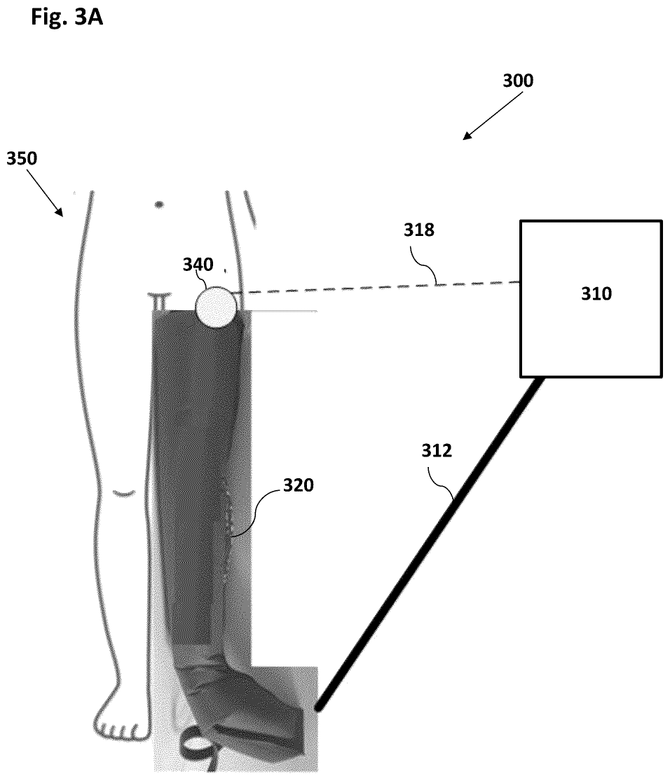

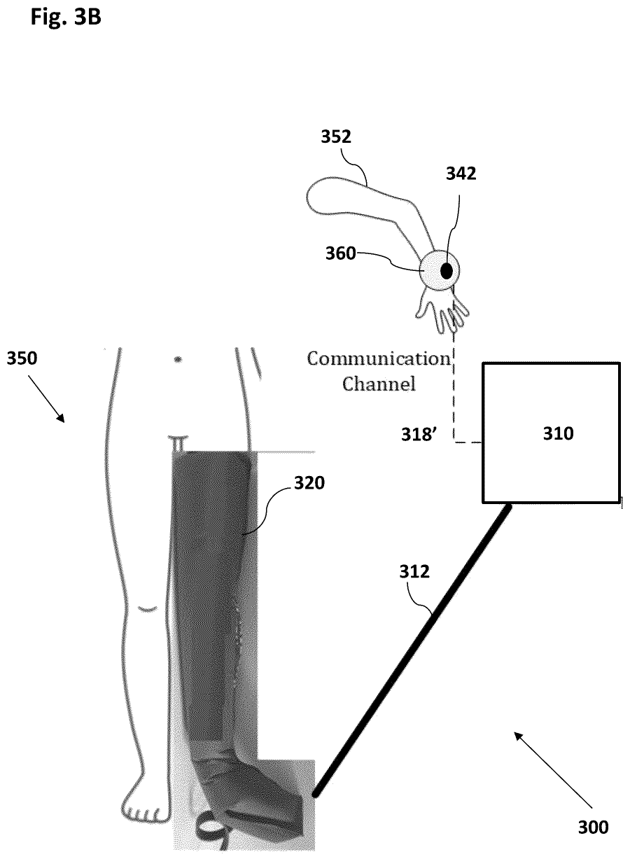

Reference is now made to FIG. 3A, schematically showing a compression system associated with a stand-alone sensor, according to some embodiments. As shown in FIG. 3A, compression system 300 includes compression garment 320 and controller device 310, which are connected thereto via fluid tubes 312, configured to provide/release fluid (such as air) from chambers of the garment, as explained in detail above herein. As shown, the garment, for example, in the form of a sleeve, is configured to be placed (for example, surroundingly engaging) a body region of the subject 350, such as a limb (a leg in the example shown in FIG. 3A) and to provide dynamic compression therapy to the body part, by changing the pressure in the chambers of the garment. As shown in FIG. 3A, the compression system is associated with a stand-alone heart-related sensor 340. Sensor 340 is a stand-alone in the sense that it is not part of another apparatus. Sensor 340 may be any type of heart related sensor, such as, a PPG sensor or an ECG sensor. Sensor 340 may be physically, communicatively and/or functionally associated with the compression system. For example, in some embodiments, sensor 340 may be formed with or attached to garment 330. For example, in some embodiments, sensor 340 may be placed on the body of the subject (for example, on a wrist, chest, thigh, or any other selected body region). Sensor 340 may communicate with controller device 310, to provide/receive information (continuously or intermittently) from the processing unit of the controller device, via communication route 318, which may be wired communication route, or wireless communication route (including such routes as, Bluetooth, NFC, wi-fi, etc.). In some embodiments, the communication is facilitated via the communication unit of the controller device. Thus, as detailed above, based on information from the sensor, recovery status may be computed, and treatment parameters/attributes may be adjusted accordingly.

According to some embodiments, the sensor may be included with a separate apparatus, such as, a wearable activity monitoring apparatus/device. Such activity monitoring apparatus may include any type of activity monitoring apparatus, such as, for example, but not limited to, a smart watch, heart monitoring apparatus, activity tracking apparatus, health-parameter tracking apparatus, running tracking apparatus, activity bracelet, chest straps, and the like. The sensor of the activity monitoring device may be in direct communication with the controller, such that signals from the sensor are conveyed directly (for example, by wireless route) the controller device, whereby the processing unit of the controller can compute/derive activity and/or health related data, such as, heart related parameters, such as, HRV. In other embodiments, a processing unit of the activity monitoring apparatus may process the heart related signals obtained from the sensor, and convey the processed information (such as, for example, heart rate or HRV) to the controller device. The controller device may then further process the data and/or utilize such obtained or processed information for further determination of recovery level, and/or changes in the recovery level. Such data may then be used to adjust the compression therapy accordingly. In some embodiments, the controller device and/or the activity monitoring apparatus may be functionally and/or physically associated with a mobile communication device. The mobile communication device may be configured to execute a computerized method (such as, in the form of an application), that can remind a user to use the dynamic compression therapy, and to provide the user with direction on manually or automatically sett timing, duration, program selection, garment selection, and other parameters of the dynamic compression therapy, based on that health and activity data. In some embodiments, the health and/or exercise/activity data may be obtained from the activity monitoring apparatus (wearable device).

According to some embodiments, the controller device can adjust treatment parameters for improving efficiency of recovery session. The adjustment may be performed for example, on duration of treatment, amount of pressure, frequency, order of activated chambers, and the like. For example, when using data obtained from a sensor harbored in a tracking apparatus, optionally, HRV and/or heart rate may be monitored for an extended period of time after recovery session and evaluate recovery pattern accordingly. For example: The apparatus may compute that full recovery (reaching baseline HRV and/or heart rate) had occurred X hours after completing the last compression treatment recovery session. In such configuration, the controller device may determine efficiency of recovery compression treatment session according to the time it takes for reaching full recovery, and accordingly maintain or adjust operation parameters in subsequent recovery session. For example, recovery compression treatment session in a first time point (for example, Day 1), may include attributes of X mmHg pressure, for N minutes length of time. In parallel, long term monitoring of recovery (by the tracking apparatus) may determine the HRV increased from Y1 to Y2 after N1 hours. Recovery compression treatment session in a following time point (for example, Day 2) may include attributes of pressure X mmHg, for N minutes of session duration. In parallel, long term monitoring of recovery (by the tracking apparatus) may determine that the HRV has increased from Y1 to Y2 after N2 hours, wherein N2 is lower than N1. Thus, the controller device may determine that increasing the pressure during the next compression treatment session is beneficial and can enhance or promote recovery.

Reference is now made to FIG. 3B, schematically showing a compression system associated with a sensor included in an activity monitoring apparatus, according to some embodiments. As shown in FIG. 3B, compression system 300 includes compression garment 320 and controller device 310, which are connected thereto via fluid tubes 312, configured to provide/release fluid (such as air) from chambers of the garment, as explained in detail above herein. As shown, the garment, for example, in the form of a sleeve, is configured to be placed (for example, surroundingly engaging) a body region of the subject 350, such as a limb (a leg in the example shown in FIG. 3B) and to provide dynamic compression therapy to the body part, by changing the pressure in the chambers of the garment. As shown in FIG. 3B, the compression system is associated with a sensor 342, which is harbored or is an integral part of activity monitoring apparatus 360. Activity monitoring apparatus 360 may be placed on a body region of the subject (for example, wrist, chest, thigh, or any other selected body region). In the example shown in FIG. 3B, apparatus 360 is placed on wrist 352 of the subject. Sensor 342 may be any type of heart related sensor, such as, a PPG sensor or an ECG sensor. Sensor 342 may be directly or indirectly functionally or communicatively associated with the compression system. For example, in some embodiments, information from the sensor may be conveyed directly to controller device 310, via communication route 318′, and the signals may be processed by the processing unit of the controller device, to derive cardiac related parameters. For example, in some embodiments, signals from sensor 340 may be processed by the processor of the activity monitoring apparatus 360, and health and/or activity related data (such as, heart related data) derived thereby can be conveyed/transferred/transmitted to controller device 310 via communication routes 318′. Thus, activity monitoring apparatus 360 may be functionally or communicatively associated with controller device 310. Communication route 318′, may be wired communication route, or wireless communication route (including such routes as, Bluetooth, NFC, wi-fi, etc.). In some embodiments, the communication is facilitated via the communication unit of the controller device. Thus, as detailed above, based, directly or indirectly on information from the sensor of the activity monitoring apparatus, recovery status may be computed, and treatment parameters/attributes may be adjusted accordingly.

In some embodiments, the controller device and/or the activity monitoring apparatus may be functionally and/or physically associated with a mobile communication device. The mobile communication device may be configured to execute a computerized method (such as, in the form of an application), that can remind a user to use the dynamic compression therapy, and to provide the user with direction on manually or automatically sett timing, duration, program selection, garment selection, and other parameters of the dynamic compression therapy, based on that health and activity data. In some embodiments, the health and/or exercise/activity data may be obtained from the activity monitoring apparatus (wearable device).

According to some embodiments, the controller unit (in particular, the processing unit thereof) may further be configured to store data (for example, in a memory module) obtained from the sensor (directly or in directly, raw data or processed data) and to further process the data to determine a personalized and/or optimized compression cycle. In some embodiments, the determination of a personalized and/or optimized compression cycle may include the use of machine learning algorithms, which may take into account, inter alia, heart related parameters of the subject from one or more previous treatment cycles or exercise cycles. In some embodiments, additionally, heart related data may further be obtained from one or more databases (such as, for example, server or cloud based databases). In some embodiments, a reliability score related to the quality of the compression cycle with respect of expected recovery may be calculated. In some embodiments, the reliability score may be produced by the machine learning algorithms and may further be used by the machine learning algorithm(s) to increase the reliability (i.e., accuracy and customization) of the compression cycles, to better characterize and identify recovery levels and/or in particular, to enhance recovery from exercise.

In some embodiments, for the determination of recovery level, various subject characteristics may further be utilized. According to some embodiments, cardiac-related data (such as, HRV and/or heart rate) which is utilized to determine recovery level, may be further processed/interpreted/utilized in the context of specific characteristics of the individual subject, including, for example, age, gender, medical condition, lifestyle factors, base-line physical shape, type of exercise, intensity of exercise, and the like, or any combinations thereof. Each possibility is a separate embodiment.

According to some embodiments, the controller device is configured to operate continuously over an extended or uninterrupted period of time, or intermittently, over sessions of various length (for example, 5 minutes to 2 hours).

According to some embodiments, the systems and devices disclosed herein may be used in a method of applying compression therapy to a subject in need thereof.

In some embodiments, the compression treatment may be provided continuously or intermittently. In some embodiments, the compression treatment may be provided in sessions. In some embodiments, the treatment session may be repeated at least once, 2, 4, 6 or more times a day, at any desired time interval therebetween. In some embodiments, each two consecutive treatment sessions may be identical, similar or different therefrom. In some embodiments, the length of a treatment session may be in the range of about 2 minutes to about 2 hours.

According to some embodiments, the compression cycles/sessions may be sequential, peristaltic and/or intermittent.

According to some embodiments, there is provided a method for providing or applying a dynamic compression therapy for exercise recovery to a subject in need thereof, the method includes one or more of the steps of: placing a compression garment on a body part of the subject (for example, leg), and controlling the pressure in the compression garment in accordance with treatment regime (cycle), wherein data from an associated heart related sensor is used (directly or indirectly) by the controller device of the compression system, to compute heart related parameters, and based thereon to determine recovery status. Based on the recovery status, the compression therapy may be adjusted/customized to the subject, to facilitate/promote recovery of the subject.

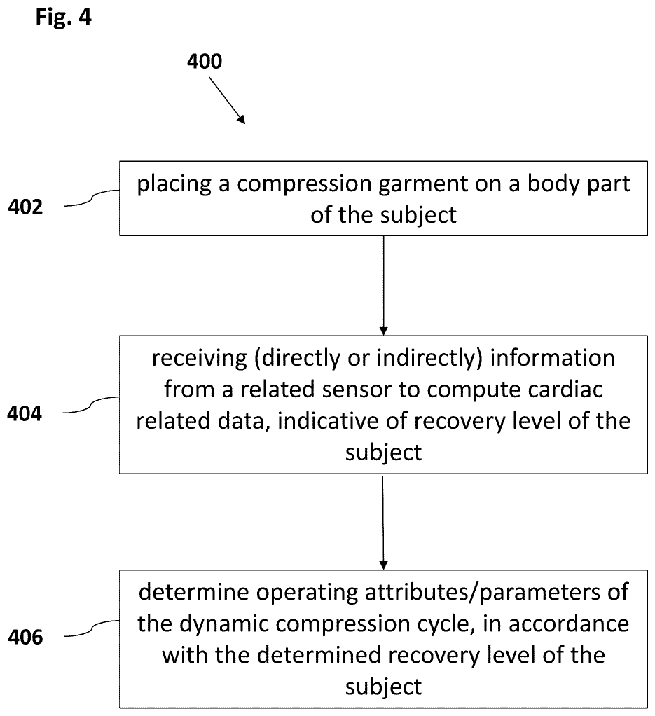

Reference is made to FIG. 4, which is a block diagram of steps in a method 400 of applying dynamic compression therapy to promote recovery form exercise, according to some embodiments. As shown in FIG. 4, step 402 includes placing/wearing a compression garment on a body part of the subject, for example, a limb, such as a leg. Step 404 includes receiving (directly or indirectly) information from a heart related sensor to compute cardiac related data, indicative of recovery level of the subject. At step 406, the method includes determining operating attributes/parameters of the dynamic compression cycle, in accordance with the determined recovery level. According to some embodiments, the steps of the method may be repeated continuously or intermittently for any number of times, for any desired period of time.

In some embodiments, the step of receiving information from a sensor and/or computing heart related data may be performed continuously or intermittently.

According to some embodiments, the controller unit includes a processing unit or module. According to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices. Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus. The processes and displays presented are not inherently related to any particular computer or other apparatus. Various general-purpose systems may be used with programs in accordance with the teachings herein, or it may prove convenient to construct a more specialized apparatus to perform the desired method(s). In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Or processing unit. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although steps of methods according to some embodiments may be described in a specific sequence, methods of the invention may comprise some or all of the described steps carried out in a different order. A method of the invention may comprise all of the steps described or only a few of the described steps. No particular step in a disclosed method is to be considered an essential step of that method, unless explicitly specified as such.

Although the invention is described in conjunction with specific embodiments thereof, it is evident that numerous alternatives, modifications and variations that are apparent to those skilled in the art may exist. Accordingly, the invention embraces all such alternatives, modifications and variations that fall within the scope of the appended claims. It is to be understood that the invention is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the invention. Section headings are used herein to ease understanding of the specification and should not be construed as necessarily limiting.

### EXAMPLES

### Example 1—Adjustment of Dynamic Compression Therapy in Accordance With Recovery Level of a Subject, Based on Signals Obtained From a Stand-Alone Sensor

In this example, a compression system includes a compression garment in the form of a sleeve, fitted on a leg of a subject recovering from exercise. The sensor includes a stand-alone PPG, positioned on the thigh of the subject, and communicably associated with the controller device of the compression system by Bluetooth.

The signals generated by the sensor are conveyed to the processing unit of the controller device and cardiac related data, including, HRV and heart rate, are computed based thereon:
In a first stage, measurements are taken in a rest position of the subject. The sensor's readings are collected and computed to establish a baseline heart rate and HRV. These base line values are stored in the memory module of the controller unit.
   Baseline value is considered as the heart rate and HRV in state of body rest and may be established after first measurement at rest position.
In subsequent treatment cycles, heart rate HRV are computed and compared to baseline, to evaluate recovery status. As long as the computed HRV is lower than the determined HRV baseline and/or the heart rate is higher than the heart rate baseline, it is concluded by the controller that further recovery using dynamic compression therapy is needed. If HRV level is below the given threshold and/or heart rate is above given threshold, the controller device unit may change treatment attributes, including, for example, increase compression treatment frequency, increase treatment pressure and/or treatment duration. When HRV value is above the given threshold and/or heart rate is below the given threshold the device control unit may stop the treatment, an indication such as, for example, an informational message may be provided to the patient indicating the recovery status is adequate.

Obtaining the signals from the sensor and adjusting the treatment parameters by the controller device accordingly is done continuously through the duration of the treatment.
In some instances, the controller device may monitor pattern changes in values (HRV and/or heart rate) during treatment and compare such patterns to reference (known) patterns (obtained from databases or from previous treatment cycles of the subject), for evaluating recovery efficiency. The controller device may determine changing/adjusting a set of treatment parameters (such as, time, pressure, frequency, etc.), to make treatment more efficient for recovery.
The system can adjust treatment parameters for improving efficiency of recovery session, by, for example, determine optimal treatment duration as follows:
At beginning of recovery sessions (T₀), HRV and/or heart rate are measured as follows: HRV (@T₀)=80, Heart Rate (@T₀)=90
HRV and/or heart rate are measured and calculated continuously during recovery session and such after T1 period of time, according to previous data learning, values are expected to be as follows: HRV (@T1)=60, Heart Rate (@T1)=70
Error is computed as follows:
   Error_HRV (@T1)=60−50=10, Error_Heart rate (@T1)=70−68=2
Treatment duration is adjusted as follows:
   additional treatment duration=Max(1.5*Error_HRV, 3*Error_Heart rate)=15 minutes

Thus, updated treatment duration would be: T1+15 minutes

Similarly, other treatment parameters may be adjusted, to promote and enhance recovery of the subject from exercise.

### Example 2—Adjustment of Dynamic Compression Therapy in Accordance With Recovery Level of a Subject

In this example, a compression system includes a compression garment in the form of a sleeve, fitted on a leg of a subject recovering from exercise. The sensor is included with a separate performance/activity tracker apparatus (including a processor, memory and communication units), that may be positioned on the wrist of the subject, and be communicably associated with the controller device of the compression system by Bluetooth.

The activity tracker apparatus is capable of monitoring HRV and/or heart rate for long period of time after a recovery compression treatment session and evaluate recovery pattern.

For example, the apparatus may determine that, based on the cardiac related data, full recovery (e.g., reaching baseline HRV and/or heart rate) has occurred seven hours after completing the last recovery compression treatment session. In such configuration, the controller device may also determine efficiency of recovery session according to time it takes for reaching full recovery, to maintain or adjust operating parameters/attributes in subsequent recovery session(s).

For example:
Recovery compression treatment session in first time point included the following attributes: Pressure=50 mmHg, Session duration=30 minutes
Long term monitoring of recovery (by the tracking apparatus) indicates that the HRV increased from 40 to 70 after 7 hours.
Recovery compression treatment session in a second timepoint included the following attributes: pressure=70 mmHg, session duration=30 minutes
Long term monitoring of recovery (by the tracking apparatus) indicates that HRV increased from 40 to 70 after 6 hours (i.e., one hour shorter than the previous time point).
Accordingly, the controller device may determine that increasing the pressure of the compression therapy would be beneficial and hence, pressure in the chambers is increased for the next treatment session.

What is claimed is:

1. A compression system for providing dynamic compression therapy for recovery from exercise, to a subject in need thereof, the compression system comprising:
a wearable compression garment configured to be surroundingly engageable around a limb of the subject, said garment comprising a plurality of inflatable chambers; and
a controller device, configured to control operation parameters of the inflatable chambers, based on health related data and/or activity data, said health related data and/or activity data comprise cardiac-related data, derived from signal(s) obtained from a related sensor associated with the subject; to thereby provide adjusted dynamic compression therapy to the subject to thereby enhance recovery from exercise.

2. The compression system according to claim 1, wherein the sensor is a wearable sensor, or wherein the sensor is embedded in the wearable compression garment.

3. The compression system according to claim 1, wherein the sensor is connected to a communication unit of controller device by wired route or wireless route.

4. The compression system according to claim 1, wherein the signal(s) comprise electrical activity of the heart or changes in blood volume in peripheral blood vessels.

5. The compression system according to claim 1, wherein the cardiac related data is processed by a processing unit of the controller device, or by an external processing unit.

6. The compression system according to claim 5, wherein the external processing unit is associated with a wearable activity tracking apparatus.

7. The compression system according to claim 6, wherein the wearable activity tracking apparatus and/or an associated mobile computing device are configured to execute a method configured to do one or more of:
(i) remind the subject to use the compression system based on the health and/or exercise/activity data;
(ii) provide the subject with instructions for setting operation parameters of the dynamic compression therapy based on the health and/or activity data;
(iii) communicate with the controller device to automatically set the operation parameters of the dynamic compression therapy based on the health and/or activity data.

8. The compression system according to claim 1, wherein the cardiac related data is determined continuously, or at discrete time points, over a period of time and/or wherein the cardiac related data is determined prior to a compression treatment session, during a compression treatment session and/or after a compression treatment session.

9. The compression system according to claim 1, wherein a baseline of a cardiac related data is determined at rest position, prior to or at start of the compression treatment session, to establish a baseline of the cardiac related data.

10. The compression system according to claim 1, further configured to compute, by a processor, a trend in the cardiac related data, or parameters related thereof.

11. The compression system according to claim 1, wherein the cardiac related data comprises heart rate, heart rate variability (HRV) and/or parameters related thereto.

12. The compression system according to claim 1, wherein the chambers are configured to inflate, deflate or maintain pressure therein, individually, concomitantly and/or sequentially.

13. The compression system according to claim 1, wherein operating parameters comprise one or more of: order of operation of the chambers, length of operation, target pressure in chambers, time to reach or maintain target pressure in chambers, time length to inflate the chamber to a target pressure, time length over which a chamber is inflated (hold time); time length between operation of sequential chambers; frequency of operation; length of compression session.

14. The compression system according to claim 1, further comprising a communication unit, configured to enable communication with an external sensor and/or an external processor.

15. The compression system according to claim 1, configured to adjust the compression treatment in real time, based on continuous determination of the cardiac-related data.

16. A method for providing adjusted dynamic compression therapy for recovery from exercise to a subject in need thereof, the method comprising:
placing the wearable compression garment according to claim 1, on a limb of the subject;
determining or receiving cardiac-related data derived from signals obtained from a related sensor associated with the subject; and
controlling the operation of the inflatable chambers, to provide adjusted dynamic compression therapy to the subject, to thereby enhance recovery from exercise.

17. The method according to claim 16, further comprising issuing an alert to the subject regarding the determined status of exercise recovery; and/or adjusting one or more treatment parameters, if the obtained cardiac related data or trend thereof, is indicative of exercise recovery below a threshold recovery value.

18. The method according to claim 16, further comprising providing a compression treatment regime recommendation to the user, based on the obtained cardiac related data or trend thereof.

19. A method of using a compression system for providing dynamic compression therapy for recovery from exercise, to a subject in need thereof, the method comprising:
providing a wearable compression garment configured to be surroundingly engageable around a limb of the subject, said garment comprising a plurality of inflatable chambers; and
providing a controller device, configured to control operation parameters of the inflatable chambers,
providing a wearable sensor worn by a subject user to provide health and/or activity data associated with the subject user;
providing a mobile computing device configured to communicate with the controller device and the wearable sensor, and
providing an application on the mobile computing device wherein the application is configured to do one or more of:
(i) reminding the subject user to use the compression system based on the health and/or activity data;
(ii) providing the subject user with instructions for setting the operation parameters of the dynamic compression therapy based on health and/or activity data; or
(iii) communicating with the controller device to automatically set the operation parameters of the dynamic compression therapy based on the health and/or activity data;
to thereby provide adjusted dynamic compression therapy to the subject to thereby enhance recovery from exercise.

20. The method according to claim 19, wherein the sensor is: a wearable sensor; a sensor which is or is associated with a smart watch, a sensor embedded in the wearable compression garment; or any combinations thereof.

21. The method according to claim 19, wherein the mobile computing device is configured to communicate with the controller device using wireless route comprising Bluetooth, NPC and/or Wi-Fi.
